(19) United States
(12) Patent Application Publication
(10) Pub. No.: US 2020/0356373 A1
(43) Pub. Date: Nov. 12, 2020

(54) PROCESS FOR THE AUTOMATIC GENERATION OF PARALLEL CODE

(71) Applicant: Università degli Studi di Siena, Siena SI (IT)

(72) Inventors: Sandro BARTOLINI, Siena (IT); Biagio PECCERILLO, Siena (IT)

(21) Appl. No.: 16/632,252

(22) PCT Filed: Jul. 13, 2018
(86) PCT No.: PCT/IB2018/055189

§ 371 Date: Jan. 17, 2020

(30) Foreign Application Priority Data
Jul. 19, 2017 (IT) 102017000082213

(51) Int. Cl. G06F 9/38; G06F 9/50; G06F 8/41

(52) U.S. Cl. CPC G06F 9/3842; G06F 9/3877; G06F 8/456; G06F 9/5044; G06F 8/443; G06F 9/5061

(57) ABSTRACT

Process for the automatic generation of parallel code, at a high level of abstraction, executable on electronic calculators having heterogeneous multi-core or many-core architectures.

The present invention deals with a process for the automatic generation of parallel code at a high level of abstraction, executable on electronic calculators with multi-core, many-core, or hybrid heterogeneous architectures.

### BACKGROUND

Until the early 2000s, electronic calculators had a “uniprocessor” architecture, since their functions were carried out by a single programmable processing unit (processor). During this period, in order to improve the performance of their electronic calculators, many hardware manufacturers focused mainly on strengthening the features of these individual processors, e.g., by trying to increase the CPU frequency or by increasing the exploitation of the ILP (Instruction Level Parallelism) as much as possible, i.e., the average number of independent instructions executed at the same time.

Starting from the last decade, hardware manufacturers found that further performance improvements of the individual processors were increasingly difficult to achieve and increasingly expensive too. They have therefore started to develop processors in which the increase in performance is due mainly to the replication of units that are similar to complete, traditional processors (“core”), able to operate at the same time on the same chip.

All this has been, and is currently possible, thanks to the progression of electronic technology that is able to produce ever smaller transistors, logical circuits and, for this reason, cores, on the same Silicon die. These electronic calculators, defined as parallel “multi-core” calculators, almost entirely superseded the use of computers employing “uni-core” architecture.

At the same time, this development has also witnessed the progressive exploitation of the multiple cores (that reached the thousands, from which the word “many-core”) in the Graphic Processing Units (GPU) for the execution of more and more general computations, not only related to the graphic applications that inspired their architecture (e.g., 3D rendering).

So, because of this approach, called “General Purpose computing on Graphics Processing Units (GPGPU)”, current GPUs can be programmed and used to execute various computations in parallel.

Therefore, today the most widespread calculators are the ones having a parallel multi-core or many-core architecture, possibly heterogeneous, that is characterized by the presence of multiple processing units, CPUs and/or GPUs.

To make the most of the features of a multi-core or many-core heterogeneous architecture, it is necessary to choose how to use the processors and/or the GPUs in parallel based on the nature of the industrial application at hand or the problem to solve. That is, how to efficiently split, assign and coordinate the computational load on them.

Some examples of industrial applications that need high-performance parallel calculation are: financial algorithms, such as pricing of complex financial products through Monte Carlo simulation; modelling of phenomena and/or physical structures in various sectors, such as automotive (e.g., crash-test simulations or design), construction (for building simulation), celestial mechanics, electromagnetism, fluid dynamics, etc.; multimedia elaboration, such as images, videos, 3D augmented/virtual reality, data elaboration from physical experiments, medical diagnostics; artificial intelligence, such as learning and classification algorithms; biomedical algorithms, such as genomic investigation techniques, protein folding, etc.

Given the vastness of the industrial uses that parallel computing codes can have, it is important that programmers can make the most of the overall performance provided by the various computing units.

However, to do this it is necessary to resort to rather complex parallel programming strategies. The most immediate way to write parallel computing code is to use a specific semantics for this type of programming, which is typically not very intuitive and therefore difficult to use, to tune and verify in terms of correctness.

In fact, writing code for parallel architectures requires far more effort from programmers in terms of reasoning, testing, and debugging, with respect to implementing algorithms in sequential code.

Another inconvenient of the current methods of writing parallel code to implement algorithms is due to the fact that written code requires an approach to the solution of the problem, a writing style and an optimization strategy that are strongly bound to the parallel architecture where the code must be executed, it is, thus, not very re-usable on different architectures.

Moreover, to develop parallel computational codes to be runnable on computers with substantially different architectures, these codes must be compatible with both types of computing units, i.e., processors and GPUs. So far, no method has been developed that allows programmers to effectively write parallel code compatible with both processors and GPUs at a high-level of abstraction, or simply with GPUs from different vendors, without forcing programmers to explicitly express and organize it depending on the details of each architecture.

### Technical Problem Solved by the Invention

The purpose of the present invention is therefore to solve the problems of the ordinary parallel programming techniques, by means of a method for the automatic generation of parallel code for the implementation of algorithms, executable on computers having multi-core or many-core heterogeneous architecture, as defined in claim 1.

A further object of the present invention is a program for an electronic calculator, as defined in claim 11.

This method allows the automatic generation of parallel code starting from code written according to the structures typically used in sequential coding, such as containers (data structures, classes, etc.), iterators, and algorithms similar to the ones adopted, for instance, in the C++ STL (Standard Template Library).

Therefore, starting from code developed in a sequential fashion, the method described in the invention is responsible for autonomously generating a corresponding parallel code and the defining how the operations in it must be implemented on the specific architecture where it is meant to execute.

The method described in the invention, allowing the programmer to use canonical sequential programming structures and autonomously taking care of generating the parallel code, facilitates the programmer's task.

In fact, the use of this method considerably reduces objective metrics generally adopted to measure the complexity of programs and the effort to implement them, such as “Lines of Code” (LOC), “Halstead's mental discriminations” and “McCabe's total cyclomatic complexity”.

Moreover, since the code written by the programmer is expressed independently from the architecture of the electronic calculator where it will be implemented, it is easily re-usable on calculators having different architectures.

Finally, this method allows the optimization of the generated parallel code with respect to the architecture of the electronic calculator where it is implemented. Optimization occurs by inferring some parallelization parameters that regulate the management and the flow of the computation. These parallelization parameters are independent of the architecture and can have an influence on the use of hardware resources. In other words, the same code can be compiled by applying different parallelization parameters, so to produce the same program suitable for different architectures.

Therefore, the crucial aspect of the method described in the invention consists in the complete decoupling between the tuning of such parallelization parameters and the actual expression of the computation: the code written by the programmer, using structures typical of sequential programming, expresses the operations that he/she intends to have the computer execute to solve a particular problem, while the procedure for the generation of the parallel code and its optimization, preferably done automatically, are refined in order to make the most of the overall performance of the computing units of the specific architecture of execution.

In particular, the exploration of various configurations and optimization techniques of the execution of the parallel code can be done with no modifications to the code written by the programmer, unlike what would happen if the latter were developed for a specific architectures and then intended to be targeted to a different architecture.

Further characteristics of the present invention are defined in the corresponding dependent claims.

Other advantages, along with the characteristics and the mode of use of the present invention, will be evident from the following detailed description of its preferred embodiments, presented for illustrative and non-limitative purposes only.

### BRIEF DESCRIPTION OF THE FIGURES

A reference to the drawings in the attached figures will be done, in which:

FIG. 1 represents a flow diagram that sums up the method described in the invention;

FIG. 2A represents the partition of a matrix in rows;

FIG. 2B represents the partition of a matrix in individual elements;

FIG. 2C represents the partition of a matrix in sub-matrices;

FIG. 3 represents the calculation of the average of each face of tensor.

### DETAILED DESCRIPTION OF POSSIBLE EMBODIMENTS OF THE INVENTION

The present invention will be described in the following referring to the above figures.

As already stated, generally, a programmer's goal is to solve a problem, through an electronic calculator that will execute an algorithm.

More specifically, the programmer defines the algorithm as a sequence of operations that, as soon as they are executed on input data, return output data that represent the solution to the problem.

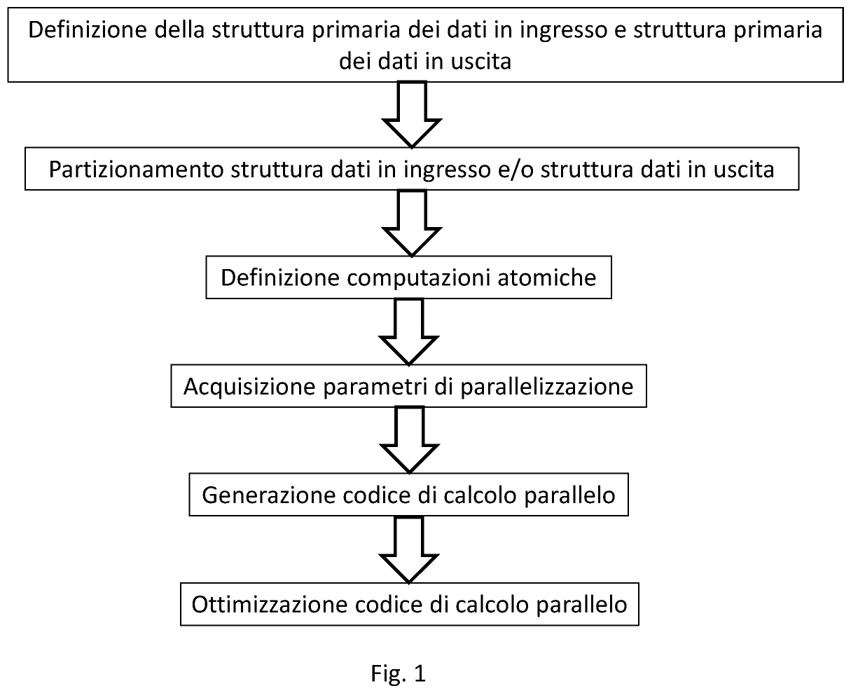

As shown in FIG. 1, a process according to the present invention allows, through successive steps, the parallel execution of the instructions defined by the programmer at a high level of abstraction, autonomously determining how this parallel calculation must take place to optimize the execution of the algorithm on the processor.

Initially, the programmer must define the algorithm, i.e., the sequence of operations that the processor will execute on a particular input data structure and that will return a corresponding output data structure as a result. In particular, to do so, the programmer must specify the primary input and/or output data structures and the corresponding partitions to consider, if any, i.e., portions of structures of lower hierarchy with respect to the primary data structures. The operations will be executed on these and the output data at the end of the algorithm execution will be saved in these.

Preferably, every partition of lower hierarchy with respect to the primary data structure from which it derives can be used in an agnostic way (i.e., independently) with respect the characteristics of the latter.

A data structure represents the entity used to organize a set of data. In particular, a data structure can be defined according to one or more axes, i.e., the so-called dimensionality of the structure. For instance, a vector is a mono-dimensional data structure that stands on a single axis (e.g., indexed by the index i), while a matrix is a bi-dimensional structure that consists of two axes (e.g., indexed by two indexes i and j).

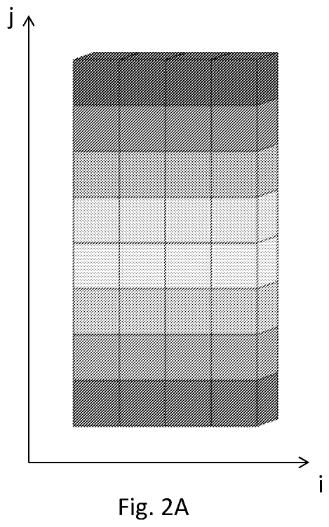

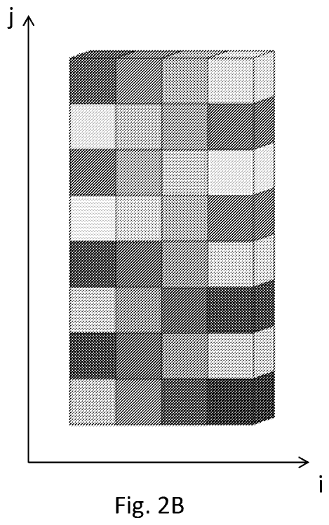

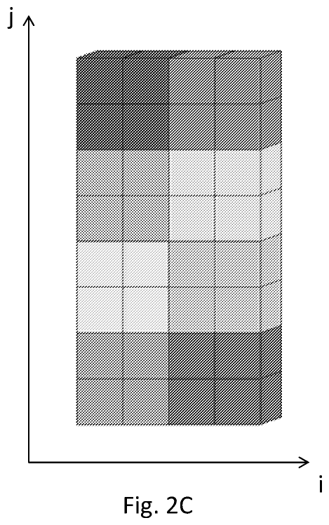

The decomposition of a data structure can take place in two ways. The first way (“slice”) establishes that the partitions are obtained by “zeroing” one or more axes of the primary data structure. For instance, a matrix structure, defined along two axes (i, j) can be partitioned in rows (as shown in FIG. 2A) or in columns (1-dimensional partitions), respectively with spatial extension along the axis i or j, zeroing the axis j or i. Or, as shown in FIG. 2B, it can be partitioned in individual elements (0-dimensional partitions) by zeroing both axes.

Another example is about a tensor structure, a 3-dimensional structure made of three axes (i, j, k). A tensor can be partitioned in matrices (2-dimensional partitions) with spatial extension along the axes ij, ik, or jk, by zeroing the axes k, j, or i, respectively, in vectors (1-dimensional partitions) with spatial extension along the axes i, j, or k, by zeroing the axes jk, ik, or ij, respectively, or in individual elements (0-dimensional partitions) by zeroing all the three axes at the same time.

The second way (“grid”) permits obtaining partitions of the same dimensionality of the primary data structure. For instance, referring to FIG. 2C, a matrix can be partitioned in sub-matrices.

The partitioning of the primary data structure can be done by the programmer according to a recursive principle, i.e., by executing it several times until defining the “sub-partitions” on which the operations will be carried out.

So, the programmer must define and program (according to the rules of the sequential coding) the so-called “atomic computations”, i.e., functions that define elementary operations (useful to obtain the final result), each of which must be able to be performed on a different partition or sub-partition, independently of the others.

Since the atomic computations must be performed on different partitions or sub-partitions and are independent of each other, they can consequently be executed in parallel.

Moreover, the atomic computations are independent from the data structure which the used partition or sub-partition derives from, and also from the type architecture of the electronic calculator on which the algorithm must be executed, thus enabling a high re-usability of the code.

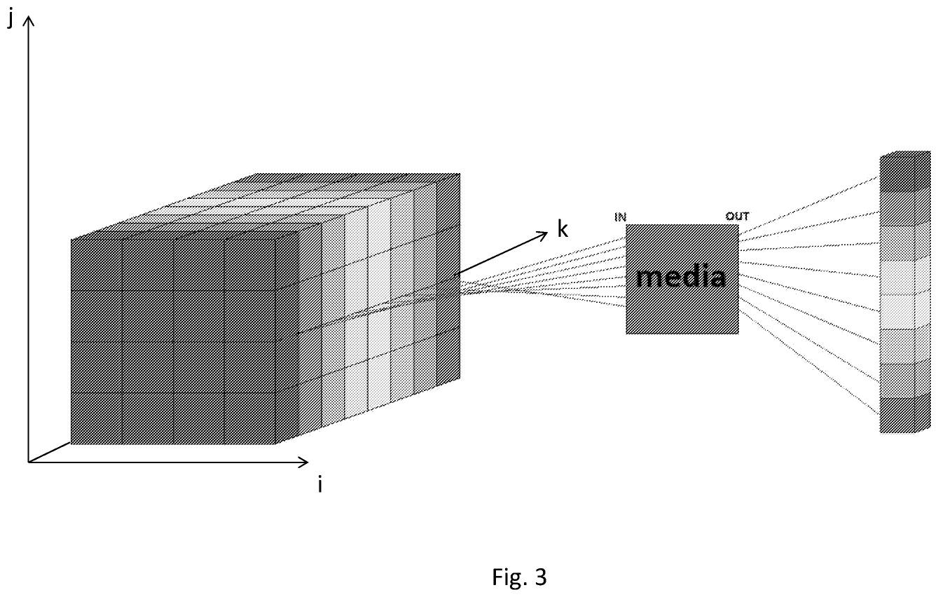

For instance, with reference to FIG. 3, supposing that the problem that the programmer is solving is to calculate the average of each face of the 3-dimensional tensor, in a first phase the programmer will specify how to partition the tensor, e.g., by zeroing the k axis, obtaining 8 faces.

The programmer must then define the atomic computations, i.e., in this case, he/she must write the code related to the operation that calculates the average of the elements of one face, the latter represented by a bi-dimensional matrix. In the definition of the atomic computations, no detail about the partitioned primary data structures is retained, so that the same atomic computation here depicted could be used to calculate the average of sub-matrices of any dimension obtained by partitioning a different data structure, for example, a matrix.

Preferably, the definition of the atomic computations is done by specifying the dimensionality of the partitions involved regardless of the dimensionality of the source data structures.

Then, the programmer generates an instruction (of even higher level) that allows the process of the invention to know which atomic computation/s must be applied to the input primary data structure (e.g., a 3-dimensional tensor) and which data structure should receive the result of the algorithm (e.g., a vector).

At this point, the process according to the present invention generates, based on logics that can be considered known here, a parallel code, i.e., it generates a series of instructions for the computer, so that it distributes and manages the flow of atomic computations on its units, threads or GPU processors. This generation of parallel code can advantageously be performed in such a way as to optimize one or more performance indexes, such as the execution speed of the algorithm.

According to an embodiment of the invention, such optimization is performed by the execution of many successive iterations on a series of parallelization parameters.

In other words, the procedure can search for the code that produces the best possible performance index by applying different combinations of parallelization parameters, iteratively.

These parallelization parameters, in a different embodiment, can be acquired directly from the system by accessing some hardware resources, e.g., in the event that the procedure is implemented directly on the computer where the execution will take place.

Otherwise, the procedure can be implemented so that the programmer himself/herself specifies said parallelization parameters, or by selecting a predefined set of parameters, chosen between some default combinations.

These parallelization parameters used in the optimization process depend on the characteristics of the processor architecture and can influence the number of calculation units used or their management. For instance, they could be: number of threads in the processors, dimensions of GPU thread-blocks, use or lack of a special memory (shared or constant) in the GPUs and consequent data management, etc.

In fact, the code execution optimization techniques are different for processors and GPUs.

As for the processors, for example, an important criterion concerns the allocation of threads to processors based on their spatial location. Inside multi-core CPUs the processors, generally a few dozen (c), can be grouped in one or more packages. The execution of parallel code on such calculators is typically more efficient in terms of execution time if the data on which a processor works are spatially close each other, i.e., they have spatial locality, thanks to the re-use of the elements in cache memories.

Since typical computations can occur on thousands (L) of partitions, thus in a much higher number than the available processors, an optimization mode involves the assignment of contiguous elements for each thread, each to be executed on a single processor.

As for GPUs, an optimization mode can concern the data access pattern, but it can be very different from the one described in the CPU case. GPUs are in fact made of thousands of simple cores. In fact, it is necessary that the threads of execution, each of which suitably indexed, work in groups of t threads on neighboring data with a “comb” access pattern, so that the first thread processes the first element of an array, the second thread processes the second element, and so on.

The group of threads is then “moved rigidly”, that is, it is made to work on the next group of t elements, and so on until the whole space of data is covered. It is also possible to define a two- or three-dimensional thread layout, an approach that can be advantageous to exploit a fine-grained parallelism inside a coarse-grained one. For example, if inside an atomic computation on a partition having dimensionality greater than zero, a computation on sub-partitions must be expressed, it is possible to do it in parallel by using the other axes that GPU technology provides.

### Example

We provide in the following a C++ sample code for calculating the average of the faces of a tensor.

Content of the .cpp source file

```
#include <iostream>
#include “phast.h”
#include “avg_functor.h”
int main(const int argc, const char* argv[ ])
{
  // initialize the tensor dimensions
  const int si = 10, sj = 4, sk = 6;
  // construct a 3-dimensional tensor with dimensions si × sj × sk
  phast::tensor<float> t(si, sj, sk);
  // construct a 1-dimensional vector having as many elements
  as there are
  // faces in the tensor, ‘sk’ this case
  phast::vector<float> avgs(sk);
  // construct the functor that embodies the computation,
  i.e., instantiate
  // avg_functor<float>defined in avg_functor.h
  avg_functor<float> avg;
  // assign some optimization parameters - these steps are optional
  // and the following parameters can be directly inferred
  phast::custom::set_n_thread(8); // number of threads on multi-core
  phast::custom::set_block_size(256, 1); //block dimension on GPU
  phast::custom::set_shared_pre_load(false); // use or lack of
  ‘shared’ memory
  // PARALLEL COMPUTATION 1: fill the tensor with uniformly
  distributed random numbers
  // in the interval [0.0, 1.0]
  phast::generate_uniform(t.begin_ijk( ), tend_ijk( ), 0.0f, 1.0f);
  // PARALLEL COMPUTATION 2: apply the ‘average’ atomic
  computation to all the
  // matrix partitions of the tensor along the k axis and the
  scalar partitions
  // of the vector
  phast::transform(t.begin_k( ), tend_k( ), avgs.begin( ), avg);
  // use of the avgs vector, now containing the average of the
  // tensor faces
  /* ... */
  return 0;
}
```

Content of the “avg_functor.h” source file

```
#include “functor_gen.h” //
//declare the ‘functor’ that embodies the atomic computation ‘average’
// on a matrix and a scalar partition, avg_functor is its type
_FUNCTOR_HEAD(avg_functor)
_MATtoSCAL_BODY(mat, out)
{
  // assign the average of the elements of the matrix partition ‘mat’
  // to the scalar partition ‘out’. It is obtained by making the sum
  // of all the elements along the axes (i, j) via the low-level library
  // function ‘accumulate_th’ and by dividing the result by their
  // number
  out = accumulate_th(mat.begin_ij( ), mat.end_ij( ), 0.0f) /
        (mat.size_i( )* mat.size_j( ));
}
_FUNCTOR_TAIL
// declare another functor that embodies the atomic computation
// ‘average of squares’ on a matrix and a scalar partition, sqr_avg_functor
// is its type
// OBSERVATION: this functor is NOT used in the program ‘.cpp’. It is
// shown for completeness, since it does not use any library functions
// but it directly expresses a computation on the matrix partition
_FUNCTOR_HEAD(sqr_avg_functor)
_MATtoSCAL_BODY(mat, out)
{
  // calculate the sum of the squares of all the elements
  // of the matrix partition ‘mat’, divide it by the number
  // of elements and assign the result to the scalar partition ‘out’
  out = 0.0f;
  for(int i = 0; i < mat.size_i( ); ++i)
  {
        for(int j = 0; j <mat.size_j( ); ++j)
        {
          out + =mat[i][j]* mat[i][j];
        }
  }
  out /= (mat.size_i( )* mat.size_j( ));
}
_FUNCTOR_TAIL
```

In the “avg_functor.h” there are two atomic computations (or functors). The first one calculates the average of the elements of a matrix (and so, it is used to calculate the averages of the faces of a 3-dimensional tensor, as specified in the “.cpp” file), while the second atomic computation, not used in the “.cpp” file, calculates the average of the squares of the elements of a matrix.

The first one uses in its body a low-level library function provided by the library “functor_gen.h” (‘accumulate_th’ calculates the sum of the elements of the partition), while the second contains only C++ native instructions with no library function invocations.

The “phast.h” file included in the source code allows programmers to take advantage of the tools made available by the invention. It includes other header files including those containing the definitions of: the data structures with the characteristics listed so far, the parallelization parameters to be used for the optimization, the algorithms and the functions that allow the generation of the parallel code starting from the sequential instructions written by the programmer in the source code.

In summary, it gives access to the programming interface.

The “functor_gen.h” file contains macros and functions to be used to define the atomic computation in the form of a functor. It contains the _FUNCTOR_HEAD definition, various body definitions (_MATtoSCAL_BODY is used in this case), _FUNCTOR_TAIL definition, etc.

Besides that, it takes care of including the files where the algorithms available in the atomic computation are defined (the ones working on sub-partitions) and the data structures needed to model the partitions inside the atomic computations.

The present invention has been so far described with reference to preferred embodiments. It is to be understood that each of the technical solution implemented in the preferred embodiments, described here by way of example, can be advantageously combined with the others in a different manner from that described, so as to give shape to additional embodiments that refer to the same invention, all of them falling within the scope of protection of the claims reported in the following.

1. A process implemented by an electronic calculator, for the automatic translation of a first sequential program in a second parallel program, executable on multi-core and/or many-core calculators, comprising:
receiving said first program in sequential form in a memory of a first calculation system which comprises a memory and at least one processor with at least one execution unit, said first program comprising one or more input and/or output primary data structures, said primary data structures being multidimensional of dimension N≥0, in which one or more said primary data structures are partitioned in one or more input and/or output partitions, each of which being a data structure having dimension≤N;
translating said first program in said second program for its efficient execution on a second calculation system comprising at least two elaboration units, said translating taking place in two sequential distinct phases, wherein in the first phase, said first program is translated in an intermediate source code, and in the second phase the intermediate source code is compiled by a CPU or GPU compiler, in which said first phase includes:
defining one or more atomic computations, each of which configured in such a way as to be connected to memory addresses of one or more of said input and/or output partitions;
acquiring one or more parallelization parameters;
if said multi-core and/or many-core calculators are GPUs:
automatically transferring the data stored in said input partitions to a GPU global memory, or an opposite in a case of output partitions; and
automatically transferring partitions of data to different types of memories in the GPU;
generating, based on said acquired parallelization parameters, a parallel code suitable for performing in parallel said atomic computations on said input and/or output partitions; and
optimizing the generated parallel code on the basis of said parallelization parameters,
in such a way that the generated parallel code is optimized with respect to one or more performance indexes.

2. The process according to claim 1, wherein each partition of the data in memory is accessible in a same way as the primary data structures from which it derives by the atomic computations, regardless of characteristics of the primary data structure of belonging, this process automatically generating code that scans memory addresses.

3. The process according to claim 1, wherein definition of the atomic computation is implemented specifying the dimension of the partitions on which it operates with no need to know the dimension of the data structures from which they derive from.

4. The process according to claim 1, wherein optimizing the generated parallel code comprises successive iterations to evaluate the performance of the implementation of said parallel code on the basis of a plurality of possible configurations of the parallelization parameters, so that to the selected and generated parallel code corresponds the best performance index.

5. The process according to claim 1, wherein the parallelization parameters used for the optimization concern characteristics of the architecture of the calculator for which the parallel code is intended.

6. The process according to claim 1, wherein the parallelization parameters used for the optimization comprise one or more of:
number of running threads; or
criteria for assigning the running threads to the processors;

7. The process according to claim 1, wherein the parallelization parameters used for optimizing the generated parallel code comprise one or more of:
organization in blocks of CUDA threads and their dimension;
automatic pre-loading of the data in shared memory;
specification of allocation of constant structures in shared memory;
selection of a number of CUDA threads to be generated; or
specification of parallelization strategy.

8. The process according to claim 1, wherein acquiring the parallelization parameters occurs by accessing hardware resources of the calculator for which the parallel code is intended.

9. The process according to claim 1, wherein optimizing the generated parallel code occurs by executing a plurality of iterations over the parallelization parameters acquired from hardware resources of the calculator for which the parallel code is intended.

10. The process according to claim 1, wherein acquiring the parallelization parameters is received from a programmer input and/or performed by selecting a predefined set of parallelization parameters, chosen among a set of predefined combinations.

11. A non-transitory computer-readable medium storing instructions executable by a computer, suitable for implementing the process according to claim 1 when executed on the calculator.

12. The process of claim 1, wherein the one or more performance indexes include at least one of Lines of Code, Halstead's Mental Discriminations, or Cyclomatic Complexity.
